(19) United States
(12) Patent Application Publication
(10) Pub. No.: US 2026/0030914 A1
(43) Pub. Date: Jan. 29, 2026

(54) FLEXIBLE FINGERPRINT SENSOR

(71) Applicant: QUALCOMM Incorporated, San Diego, CA (US)

(72) Inventors: Jessica Liu STROHMANN, Cupertino, CA (US); Hrishikesh Vijaykumar PANCHAWAGH, Cupertino, CA (US)

(21) Appl. No.: 18/787,917

(22) Filed: Jul. 29, 2024

(51) Int. Cl. G06V 40/13; B06B 1/06

(52) U.S. Cl. CPC G06V 40/1306; B06B 1/0688

(57) ABSTRACT

An apparatus may include a flexible fingerprint sensor stack. The flexible fingerprint sensor stack may include a first fingerprint sensor electrode layer, a polymer layer, a second fingerprint sensor electrode layer residing on the polymer layer and a first piezoelectric layer residing between the first fingerprint sensor electrode layer and the polymer layer. The flexible fingerprint sensor stack may have a modulus of elasticity in a range from 2-5 gigapascals (GPa). The apparatus may include an adhesive layer residing adjacent the flexible fingerprint sensor stack. The first fingerprint sensor electrode layer, the polymer layer and the first piezoelectric layer may be layers of one or more acoustic resonators configured to produce a local maximum of ultrasonic wave transmission at a frequency in a range from 1 MHz to 20 MHz. The adhesive layer may reside between the flexible fingerprint sensor stack and a display stack.

### TECHNICAL FIELD

This disclosure relates generally to fingerprint sensors and to related methods, devices and systems.

### DESCRIPTION OF THE RELATED TECHNOLOGY

Biometric authentication can be an important feature for controlling access to devices, etc. Many existing products include fingerprint sensors for biometric authentication. Although existing fingerprint sensors provide benefits, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus. The apparatus may include a flexible fingerprint sensor stack. In some examples, the fingerprint sensor stack may include a first fingerprint sensor electrode layer, a polymer layer, a second fingerprint sensor electrode layer residing on the polymer layer, and a first piezoelectric layer residing between the first fingerprint sensor electrode layer and the polymer layer. According to some examples, the apparatus may include an adhesive layer residing adjacent the fingerprint sensor stack. In some examples, the first fingerprint sensor electrode layer, the polymer layer and the first piezoelectric layer may be layers of one or more acoustic resonators configured to produce a local maximum of ultrasonic wave transmission at a frequency in a range from 1 MHz to 20 MHz.

In some examples, the fingerprint sensor stack may have a modulus of elasticity in a range from 2-5 gigapascals (GPa). According to some examples, a thickness of the fingerprint sensor stack equals a quarter wavelength corresponding to the frequency. In some such examples, the adhesive layer may be, or may include, a high-impedance layer having an acoustic impedance in a range from 10-50 MRayls. According to some examples, the polymer layer may reside between the first piezoelectric layer and the adhesive layer. In some examples, the first fingerprint sensor electrode layer may reside between the first piezoelectric layer and the adhesive layer. In some examples, the adhesive layer may be, or may include, a low-impedance layer having an acoustic impedance in a range from 1.0-5.0 MRayls. In some such examples, the apparatus may include a high-impedance spacer layer having an acoustic impedance in a range from 10-50 MRayls. The high-impedance spacer layer may, in some examples, reside between the adhesive layer and the polymer layer.

In some examples, the apparatus may include a flexible fingerprint sensor stack and a display stack. According to some examples, the display stack may be a flexible display stack or a non-planar (curved) display stack. In some examples, the adhesive layer may reside between the fingerprint sensor stack and the display stack. In some such examples, the adhesive layer and the sensor layer may have areas that are less than or equal to a display stack area. In some such examples, the apparatus may include a high-impedance stiffener layer having an acoustic impedance in a range from 10-50 MRayls. The high-impedance stiffener layer may reside between the adhesive layer and the display stack. In some examples, the adhesive layer may reside between the polymer layer and the high-impedance stiffener layer. In some such examples, the adhesive layer may be, or may include, a low-impedance layer having an acoustic impedance in a range from 1.0-5.0 MRayls. According to some examples, the first fingerprint sensor electrode layer may be, or may include, a low-impedance layer having an acoustic impedance in a range from 1.0-5.0 MRayls. In some such examples, a thickness of the fingerprint sensor stack combined with a thickness of the adhesive layer may equal a quarter wavelength corresponding to the frequency. In some examples, the first fingerprint sensor electrode layer may be, or may include, a high-impedance layer having an acoustic impedance in a range from 10-50 MRayls. In some such examples, a combined thickness of the polymer layer, the first piezoelectric layer and the adhesive layer may equals a half wavelength corresponding to the frequency.

According to some examples, the adhesive layer may be, or may include, a low-impedance layer having an acoustic impedance in a range from 1.0-5.0 MRayls. In some such examples, the first fingerprint sensor electrode layer may reside between the first piezoelectric layer and the adhesive layer. In some such examples, the first fingerprint sensor electrode layer may be, or may include, a high-impedance layer having an acoustic impedance in a range from 10-50 MRayls. In some such examples, a combined thickness of the polymer layer and the first piezoelectric layer equals a quarter wavelength corresponding to the frequency.

In some examples, a thickness of the fingerprint sensor stack combined with a thickness of the adhesive layer may equal a quarter wavelength corresponding to the frequency. In some such examples, the adhesive layer may be, or may include, a low-impedance layer having an acoustic impedance in a range from 1.0-5.0 MRayls.

According to some examples, the apparatus may include a second piezoelectric layer and a third fingerprint sensor electrode layer. In some such examples, third fingerprint sensor electrode layer may reside between the first piezoelectric layer and the second piezoelectric layer. In some such examples, the adhesive layer may be, or may include, a high-impedance layer having an acoustic impedance in a range from 10-50 MRayls. In some such examples, the polymer layer may reside between the first piezoelectric layer and the second piezoelectric layer.

In some examples, the apparatus may include a high-impedance spacer layer residing between the polymer layer and the second fingerprint sensor electrode layer. In some such examples, a first acoustic resonator may be bounded by the high-impedance spacer layer and the adhesive layer and a second acoustic resonator may be bounded on one side by the high-impedance spacer layer and may include the first fingerprint sensor electrode layer and the second fingerprint sensor electrode layer. According to some examples, the first piezoelectric layer, the second piezoelectric layer, the first fingerprint sensor electrode layer and the second fingerprint sensor electrode layer may reside between the polymer layer and the adhesive layer. In some examples, the apparatus may include a double-sided tape layer residing between the first piezoelectric layer and the second piezoelectric layer.

According to some examples, the adhesive layer may be, or may include, a low-impedance layer having an acoustic impedance in a range from 1.0-5.0 MRayls. In some such examples, the first fingerprint sensor electrode layer may be, or may include, a high-impedance layer having an acoustic impedance in a range from 10-50 MRayls.

In some examples, the apparatus may include a second polymer layer residing proximate the first fingerprint sensor electrode layer. In some such examples, the first polymer layer and the second polymer layer may be flexible polymers layers having moduli of elasticity in a range from 0.1 gigapascals (GPa) to 11 GPa. According to some examples, the second fingerprint sensor electrode layer may be, or may include, a two-dimensional array of pixelated electrodes having associated thin-film transistor (TFT) circuitry.

In some examples, the apparatus may include a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

According to some examples, the control system may be configured to control the flexible fingerprint sensor stack to perform a fingerprint authentication process.

Other innovative aspects of the subject matter described in this disclosure may be implemented via one or more methods. Some methods may involve controlling the flexible fingerprint sensor stack to perform a fingerprint authentication process.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon.

For example, the software may include instructions for controlling one or more devices to perform one or more methods. Some methods may involve controlling the flexible fingerprint sensor stack to perform a fingerprint authentication process.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1A is a block diagram that shows example components of an apparatus according to some disclosed implementations.

FIG. 1B is a block diagram that shows additional examples of apparatus components according to some disclosed implementations.

FIGS. 2A and 2B show additional examples of apparatus components according to some disclosed implementations.

FIGS. 3A and 3B show additional examples of apparatus components according to some disclosed implementations.

FIGS. 4A and 4B show additional examples of apparatus components according to some disclosed implementations.

FIGS. 5A and 5B show additional examples of apparatus components according to some disclosed implementations.

FIG. 6 shows examples of ultrasound traversing components of an apparatus according to some disclosed implementations.

FIG. 7 shows examples of processes that may be involved with transmitting and receiving ultrasonic waves.

FIG. 8 is a flow diagram that presents examples of operations according to some disclosed methods.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, augmented reality (AR) glasses, AR or virtual reality (VR) headsets, motorcycle visors, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, vehicle displays (including odometer and speedometer displays, etc.), vehicle windscreens or other vehicle components, cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Flexible fingerprint sensors have many potential advantages, including but not limited to their suitability for use in foldable display devices. However, it has proven to be very challenging to provide flexible fingerprint sensors that have acceptable performance levels. Previously-designed prototypes of flexible fingerprint sensors have suffered from relatively low-power transmitted ultrasonic waves, relatively low resolution of fingerprint image data, or both. (As used herein, the word “finger” may correspond to any digit, including a thumb. Accordingly, a thumbprint is a type of fingerprint.) One challenge of designing flexible fingerprint sensors that have acceptable performance levels has been to compensate for the lack of rigid thin-film transistor (TFT) substrate, such as a glass TFT substrate, used in previously-disclosed inflexible fingerprint sensor implementations.

Some disclosed devices may include a flexible fingerprint sensor stack. The flexible fingerprint sensor stack may include flexible fingerprint sensor circuitry, flexible fingerprint sensor electrodes and a flexible piezoelectric layer. In some implementations, an apparatus also may include a display stack. The apparatus may include an adhesive layer between the display stack and the flexible fingerprint sensor stack. According to some examples, at least some layers of the flexible fingerprint sensor stack may be, or may include, an acoustic resonator configured to produce a local maximum of ultrasonic wave transmission at a frequency in a range from 1 MHz to 20 MHz.

Particular implementations of the subject matter described in this disclosure may be implemented to realize one or more of the following potential advantages. Some disclosed flexible fingerprint sensor stacks include one or more acoustic resonators configured to produce a local maximum of ultrasonic wave transmission at a frequency in a range from 1 MHz to 20 MHz, thereby enhancing the power of ultrasonic waves transmitted by the flexible fingerprint sensor stack. Therefore, these flexible fingerprint sensor stacks can provide acceptable performance levels, including relatively higher-power transmitted ultrasonic waves and relatively higher resolution of fingerprint image data, as compared to those of previous prototypes. Flexible fingerprint sensor stacks can also be made thinner than previously-disclosed inflexible fingerprint sensor implementations: some disclosed flexible fingerprint sensor stacks may have a total thickness of 100 microns or less. Flexible fingerprint sensor stacks are suitable for attachment to non-planar surfaces, including but not limited to non-planar display surfaces. Flexible fingerprint sensor stacks are suitable for use in foldable display devices, such as foldable cell phones. Flexible fingerprint sensor stacks are relatively more durable than previously-disclosed inflexible fingerprint sensor stacks. Flexible fingerprint sensor stacks can be fabricated at a relatively lower cost than previously-disclosed inflexible fingerprint sensor stacks. Flexible fingerprint sensor stacks can be relatively easier to laminate than previously-disclosed inflexible fingerprint sensor stacks and may produce fewer trapped bubbles, particular when the flexible fingerprint sensor stacks are laminated on a flexible display stack. Flexible fingerprint sensor stacks can also provide a relatively higher resolution than fingerprint sensor stacks that include a thick (e.g., 100 micron) glass layer, because the thick glass layer can act as a filter.

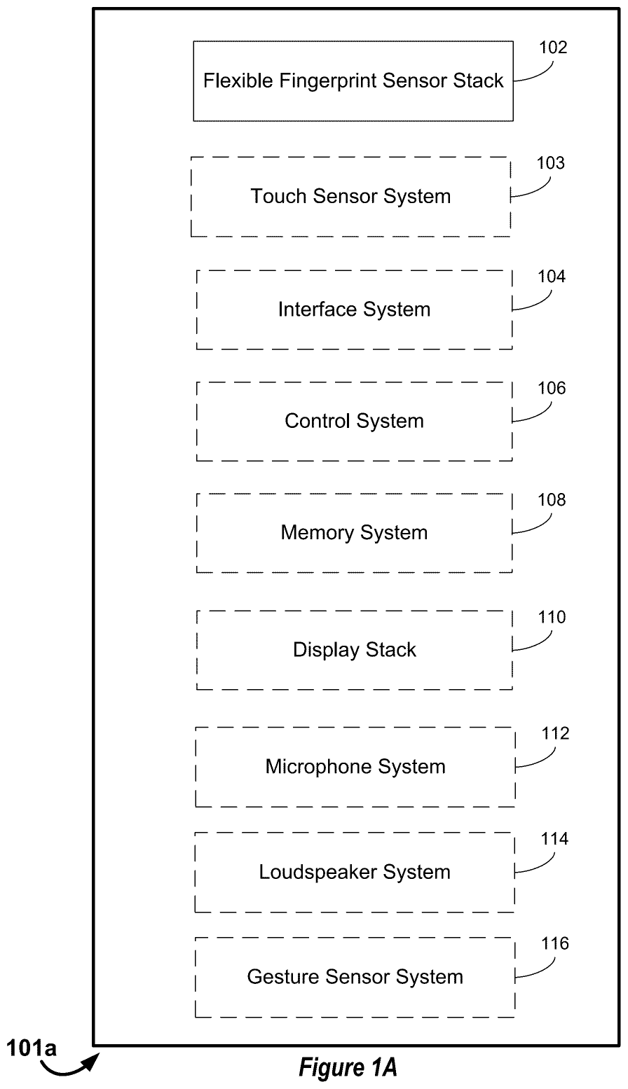

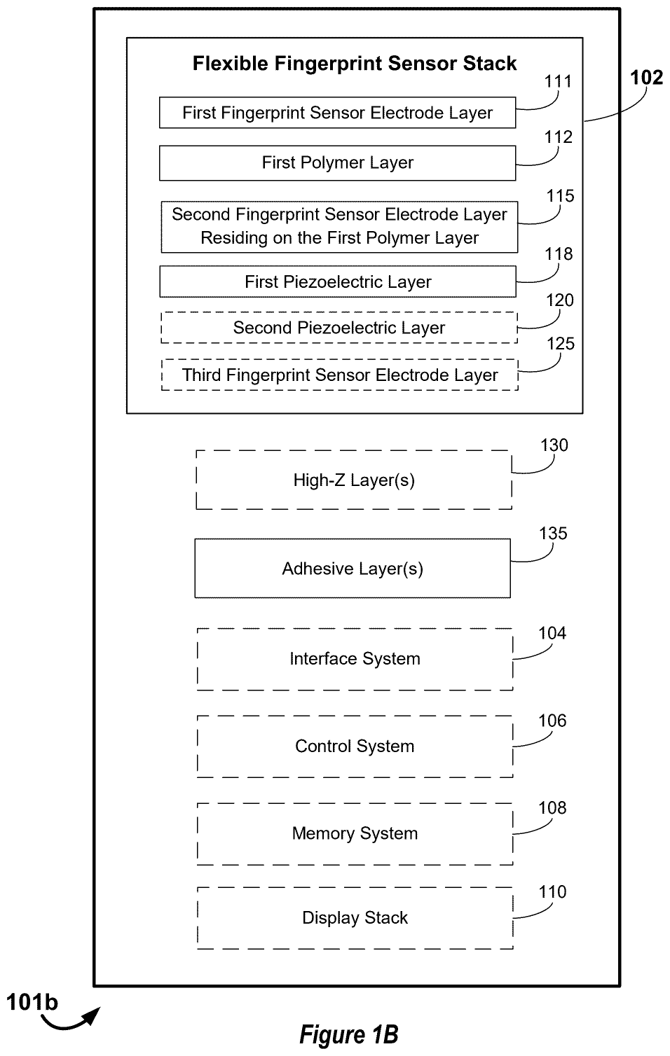

FIG. 1A is a block diagram that shows example components of an apparatus according to some disclosed implementations. According to this example, optional elements are shown with a dashed outline. In this example, the apparatus 101a includes a flexible fingerprint sensor stack 102. Some implementations may include a touch sensor system 103, an interface system 104, a control system 106, a memory system 108, a display stack 110, a microphone system 112, a loudspeaker system 114, a gesture sensor system 116, or combinations thereof. According to some examples, the apparatus 101a may be a flexible device, such as a flexible display device. In some such examples, the apparatus 101a may be a foldable display device, such a foldable cell phone. Accordingly, in addition to the flexible fingerprint sensor stack 102, other components of the apparatus 101a—including but not limited to the display stack 110—also may be flexible.

As with other disclosed examples, the types, numbers and arrangements of elements that are shown in FIG. 1A are merely presented by way of example. Other examples may include different types of elements, numbers of elements, arrangements of elements, or combinations thereof. Although not shown in FIG. 1A, the apparatus 101a may include other components, such as a cover, one or more adhesive layers, one or more electrode layers, one or more stiffener layers (for example, in foldable display device implementations), etc. Some examples are described below.

According to some examples, the flexible fingerprint sensor stack 102 may be, or may include, layers of a flexible ultrasonic fingerprint sensor. Various examples are disclosed herein. Alternatively, or additionally, in some implementations the flexible fingerprint sensor stack 102 may be, or may include, another type of flexible fingerprint sensor, such as a flexible optical fingerprint sensor, a flexible capacitive fingerprint sensor, etc.

However, below-display ultrasonic fingerprint sensors have potential advantages over, for example, below-display optical fingerprint sensors. For example, background light cancellation is difficult for under-display optical fingerprint sensors: the light transmitted through the display by the optical fingerprint sensor changes the background light levels. Below-display ultrasonic fingerprint sensors do not interfere with or degrade the performance of an overlying display.

In some examples, the flexible fingerprint sensor stack 102 may include an ultrasonic receiver array and a separate ultrasonic transmitter, or transmitter array. In some such examples, the ultrasonic transmitter may include an ultrasonic plane-wave generator. However, various examples of ultrasonic sensors are disclosed herein, some of which may include a separate ultrasonic transmitter and some of which may not. For example, in some implementations, the flexible fingerprint sensor stack 102 may include a piezoelectric receiver layer, such as a layer of polyvinylidene fluoride PVDF polymer or a layer of polyvinylidene fluoride-trifluoroethylene (PVDF-TrFE) copolymer. In some implementations, a separate piezoelectric layer may serve as the ultrasonic transmitter. In some implementations, a single piezoelectric layer may serve as both a transmitter and a receiver. The flexible fingerprint sensor stack 102 may, in some examples, include an array of ultrasonic transducer elements, such as an array of piezoelectric micromachined ultrasonic transducers (PMUTs), an array of capacitive micromachined ultrasonic transducers (CMUTs), etc. In some such examples, PMUT elements in a single-layer array of PMUTs or CMUT elements in a single-layer array of CMUTs may be used as ultrasonic transmitters as well as ultrasonic receivers.

Data received from the flexible fingerprint sensor stack 102, or from a fingerprint sensor system that includes the flexible fingerprint sensor stack 102, may sometimes be referred to herein as “fingerprint sensor data,” “fingerprint sensor signals,” “fingerprint image data,” etc., whether or not the received data corresponds to an actual digit or another object from which the flexible fingerprint sensor stack 102 has received data. Such data will generally be received from the fingerprint sensor system in the form of electrical signals. Accordingly, without additional processing such image data would not necessarily be perceivable by a human being as an image. As used herein, the word “finger” may correspond to any digit, including a thumb. Accordingly, a thumbprint is a type of fingerprint.

The optional touch sensor system 103 may be, or may include, a resistive touch sensor system, a surface capacitive touch sensor system, a projected capacitive touch sensor system, a surface acoustic wave touch sensor system, an infrared touch sensor system, or any other suitable type of touch sensor system. In some implementations, the area of the touch sensor system 103 may extend over most or all of the display stack 110.

In some examples, the interface system 104 may include a wireless interface system. In some implementations, the interface system 104 may include a user interface system, one or more network interfaces, one or more interfaces between the control system 106 and the flexible fingerprint sensor stack 102, one or more interfaces between the control system 106 and the touch sensor system 103, one or more interfaces between the control system 106 and the memory system 108, one or more interfaces between the control system 106 and the display stack 110, one or more interfaces between the control system 106 and the microphone system 112, one or more interfaces between the control system 106 and the loudspeaker system 114, one or more interfaces between the control system 106 and the gesture sensor system 116 and/or one or more interfaces between the control system 106 and one or more external device interfaces (e.g., ports or applications processors).

The interface system 104 may be configured to provide communication (which may include wired or wireless communication, electrical communication, radio communication, etc.) between components of the apparatus 101a. In some such examples, the interface system 104 may be configured to provide communication between the control system 106 and the flexible fingerprint sensor stack 102. According to some such examples, the interface system 104 may couple at least a portion of the control system 106 to the flexible fingerprint sensor stack 102 and the interface system 104 may couple at least a portion of the control system 106 to the touch sensor system 103, e.g., via electrically conducting material (e.g., via conductive metal wires or traces. According to some examples, the interface system 104 may be configured to provide communication between the apparatus 101a and other devices and/or human beings. In some such examples, the interface system 104 may include one or more user interfaces, haptic feedback devices, etc. The interface system 104 may, in some examples, include one or more network interfaces and/or one or more external device interfaces (such as one or more universal serial bus (USB) interfaces or a serial peripheral interface (SPI)).

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc. In this example, the control system 106 is configured for communication with, and for controlling, the flexible fingerprint sensor stack 102. In implementations wherein the apparatus includes a touch sensor system 103, the control system 106 may be configured for communication with, and for controlling, the touch sensor system 103. In implementations wherein the apparatus includes a memory system 108 that is separate from the control system 106, the control system 106 also may be configured for communication with the memory system 108. In implementations wherein the apparatus includes a display stack 110, the control system 106 may be configured for communication with, and for controlling, the display stack 110. In implementations wherein the apparatus includes a microphone system 112, the control system 106 may be configured for communication with, and for controlling, the microphone system 112. In implementations wherein the apparatus includes an loudspeaker system 114, the control system 106 may be configured for communication with, and for controlling, the loudspeaker system 114. According to some examples, the control system 106 may include one or more dedicated components that are configured for controlling the flexible fingerprint sensor stack 102, the touch sensor system 103, the memory system 108, the display stack 110, the microphone system 112 and/or the loudspeaker system 114.

Some examples of the apparatus 101a may include dedicated components that are configured for controlling at least a portion of the flexible fingerprint sensor stack 102 (and/or for processing data received from the flexible fingerprint sensor stack 102). Although the control system 106 and the flexible fingerprint sensor stack 102 are shown as separate components in FIG. 1A, in some implementations at least a portion of the control system 106 and at least a portion of the flexible fingerprint sensor stack 102 may be co-located. For example, in some implementations one or more components of the flexible fingerprint sensor stack 102 may reside on an integrated circuit or “chip” of the control system 106. According to some implementations, functionality of the control system 106 may be partitioned between one or more controllers or processors, such as between a dedicated sensor controller and an applications processor (also referred to herein as a “host” processor) of an apparatus, such as a host processor of a mobile device. In some such implementations, at least a portion of the host processor may be configured for fingerprint image data processing, determination of whether currently-acquired fingerprint image data matches previously-obtained fingerprint image data (such as fingerprint image data obtained during an enrollment process), etc.

According to some examples, the control system 106 may be configured to control the flexible fingerprint sensor stack 102 to transmit ultrasonic waves to a target object on an outer surface of the apparatus 101a. In some examples, the control system 106 may be configured to receive, from the flexible fingerprint sensor stack 102, fingerprint sensor signals corresponding to reflected ultrasonic waves from the target object. According to some examples, the control system 106 may be configured to perform an authentication process based, at least in part, on the fingerprint sensor signals. The authentication process may involve extracting fingerprint minutiae from the fingerprint sensor signals and comparing the fingerprint minutiae to previously-obtained fingerprint minutiae, such as fingerprint minutiae obtained during an enrollment process.

In some examples, the memory system 108 may include one or more memory devices, such as one or more RAM devices, ROM devices, etc. In some implementations, the memory system 108 may include one or more computer-readable media, storage media and/or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

In some examples, the apparatus 101a may include a display stack 110. In some such examples, the display stack 110 may be, or may include, a light-emitting diode (LED) stack, such as a microLED stack, an organic LED (OLED) stack, or combinations thereof. In some implementations, the flexible fingerprint sensor stack 102 may be integrated with the display stack 110. For example the flexible fingerprint sensor stack 102 may be integrated with a flexible display stack 110, such as a plastic OLED (POLED) display stack 110. Some disclosed flexible fingerprint sensor stacks 102 may have a total thickness of 100 microns or less. In some examples, a pOLED display stack 110 may be approximately 900 microns in thickness. Accordingly, an integrated flexible fingerprint sensor stack 102 and pOLED display stack 110 may have an overall thickness of 1000 microns or less. In some instances, the flexible fingerprint sensor stack 102 may extend over most, or all, of the viewable area of the display stack 110. Such implementations of the flexible fingerprint sensor stack 102 may be considered to be a “fingerprint panel,” which is analogous to a “touch panel” of a touch sensor system. Some disclosed flexible fingerprint sensor stacks 102 may include one or more layers of the display stack 110. In some such examples, the flexible fingerprint sensor stack 102 are necessarily, or not completely below the display stack 110.

In some implementations, the apparatus 101a may include a microphone system 112. The microphone system 112 may include one or more microphones, one or more types of microphones, or combinations thereof.

According to some implementations, the apparatus 101a may include an loudspeaker system 114. The loudspeaker system 114 may include one or more loudspeakers, one or more types of loudspeakers, or combinations thereof.

In some implementations, the apparatus 101a may include a gesture sensor system 116. The gesture sensor system 116 may be, or may include, an ultrasonic gesture sensor system, an optical gesture sensor system or any other suitable type of gesture sensor system.

FIG. 1B is a block diagram that shows additional examples of apparatus components according to some disclosed implementations. In this example, the apparatus 101a includes a flexible fingerprint sensor stack 102 and one or more adhesive layers 135. As with other drawings, the dashed lines around some elements indicates that they are optional and that they may be implemented in some, but not necessarily all, examples. Accordingly, some implementations may include a touch sensor system 103, an interface system 104, a control system 106, a memory system 108, a display stack 110, a microphone system 112, a loudspeaker system 114, a gesture sensor system 116, or combinations thereof. In this example, the apparatus 101b is an instance of the apparatus 101a that is shown in FIG. 1A. Accordingly, the flexible fingerprint sensor stack 102, interface system 104, control system 106, memory system 108 and display stack 110 shown in FIG. 1B are instances of the flexible fingerprint sensor stack 102, interface system 104, control system 106, memory system 108 and display stack 110 of FIG. 1A. In some examples, the apparatus 101b may include one or more high-impedance layers 130 having a relatively higher acoustic impedance than at least some other layers of the apparatus. As with other disclosed implementations, the numbers, types and arrangements of elements shown in FIG. 1B are merely presented by way of example.

According to this example, the flexible fingerprint sensor stack 102 includes a first fingerprint sensor electrode layer 111, a first polymer layer 112, a second fingerprint sensor electrode layer 115 residing on the first polymer layer 112, and a first piezoelectric layer 118. In some implementations, the flexible fingerprint sensor stack 102 may include a second piezoelectric layer 120, a third fingerprint sensor electrode layer, or combinations thereof. Various examples are disclosed herein.

The first fingerprint sensor electrode layer 111 may reside adjacent the first piezoelectric layer 118. In some implementations, the first fingerprint sensor electrode layer 111 may include a conductive metal, such as copper, or a conductive ink, such as silver ink.

According to some examples, the first polymer layer 112 may be, or may include, one or more polyimide (PI) layers or other flexible polymer layers. Because the fingerprint sensor stack 102 includes a flexible polymer layer 112 instead of a rigid layer, such as a glass layer, the fingerprint sensor stack 102 is flexible in this example. In some instances, the flexible polymer layer 112 may have a modulus of elasticity in the range from 0.1 gigapascals (GPa) to 11 GPa. In some such examples, the flexible polymer layer 112 may have a modulus of elasticity in the range of 2 GPa to 3 GPa.

In some examples, the first piezoelectric layer 118 may be, or may include, one or more piezoelectric copolymers, PVDF, lead magnesium niobate/lead titanate (PMN-PT), lithium niobate (LiNbO₃), or combinations thereof. According to some examples, the first piezoelectric layer 118 may be configured to function as both an ultrasonic transmitter and an ultrasonic receiver. According to some implementations, the first piezoelectric layer 118 may be a single piezoelectric layer, whereas in other implementations the first piezoelectric layer 118 may be a multilayer piezoelectric structure, or an array of such structures.

According to this example, the apparatus 101b includes one or more adhesive layers 135. In some examples, at least one adhesive layer 135 resides between the flexible fingerprint sensor stack 102 and an instance of the display stack 110. According to some such examples, the adhesive layer(s) 135 may be, or may include, ultraviolet (UV) adhesive, epoxy resin, double-sided tape, silicone adhesive, cyanoacrylate, or combinations thereof.

However, in some examples the adhesive layer(s) 135 may include one or more layers having a relatively higher acoustic impedance, such as one or more metal layers. In some examples, the adhesive layer(s) 135 may be, or may include, a double-sided copper tape.

According to some such examples, the adhesive layer(s) 135 may be an acoustic resonator boundary layer. In some examples, one or more adhesive layers 115 that reside between the flexible fingerprint sensor stack 102 and the display stack 110 may form one boundary of an acoustic resonator that includes one or more layers of the flexible fingerprint sensor stack 102. In some such examples, the acoustic resonator is configured to produce a local maximum of ultrasonic wave transmission at a frequency in the range from 1 MHz to 20 MHz.

The high-impedance layer(s) 130, when present, may reside adjacent to the adhesive layer(s) 135. The high-impedance layer(s) 130, when present, may have an acoustic impedance that is higher than an acoustic impedance of the first fingerprint sensor electrode layer 111, higher than an acoustic impedance of the first polymer layer 112, higher than an acoustic impedance of the first piezoelectric layer 118 and higher than an acoustic impedance of the adhesive layer(s) 135. In some examples, the high-impedance layer(s) 130 may have an acoustic impedance of 10 MRayls or more. According to some examples, the high-impedance layer(s) 130 may be, or may include, a metal layer (e.g., a stainless steel layer having an acoustic impedance of approximately 47 MRayls). However, in other implementations the display stiffener 113 may be, or may include, one or more other metals, or non-metal material having a relatively high acoustic impedance, such as The high-impedance layer(s) 130 may, in some examples, form one boundary of an acoustic resonator that is configured to produce a local maximum of ultrasonic wave transmission at a frequency in the range from 1 MHz to 20 MHz.

The apparatus 101a or 101b may be used in a variety of different contexts, some examples of which are disclosed herein. For example, in some implementations a mobile device, a television or other display device, a laptop computer, a windscreen or another vehicle component may include at least a portion of the apparatus 101a or 101b. In some implementations, a wearable device may include at least a portion of the apparatus 101a or 101b. The wearable device may, for example, be augmented reality (AR) glasses, an AR or a virtual reality (VR) headset, a motorcycle visor, a bracelet, an armband, a wristband, a ring, a headband, a belt or a patch. In some implementations, the control system 106 may reside in more than one device. For example, a portion of the control system 106 may reside in a wearable device and another portion of the control system 106 may reside in another device, such as a mobile device (e.g., a smartphone). The interface system 104 also may, in some such examples, reside in more than one device.

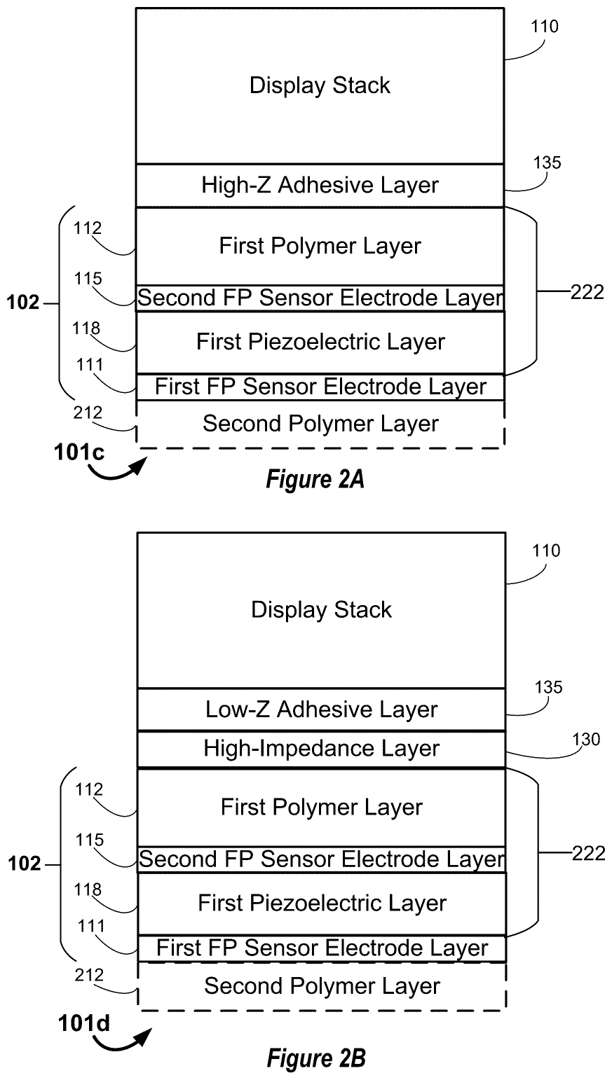

FIGS. 2A and 2B show additional examples of apparatus components according to some disclosed implementations. In these examples, the flexible fingerprint sensor stack 102 and display stack 110 are instances of the fingerprint sensor stack 102 and display stack 110 of FIGS. 1A and 1B. According to these examples, the flexible fingerprint sensor stacks 102 include a first fingerprint sensor electrode layer 111, a first polymer layer 112, a second fingerprint sensor electrode layer 115, and a first piezoelectric layer 118. According to these examples, the first piezoelectric layer 118 acts as an ultrasonic wave transmitter and as an ultrasonic wave receiver. In these examples, the second fingerprint sensor electrode layer 115 resides on the first polymer layer 112. The optional second polymer layer 212 may function—at least in part—as a passivation layer for the first fingerprint sensor electrode layer 111. In some examples, the optional second polymer layer 212 may be, or may include a die attach film (DAF) layer.

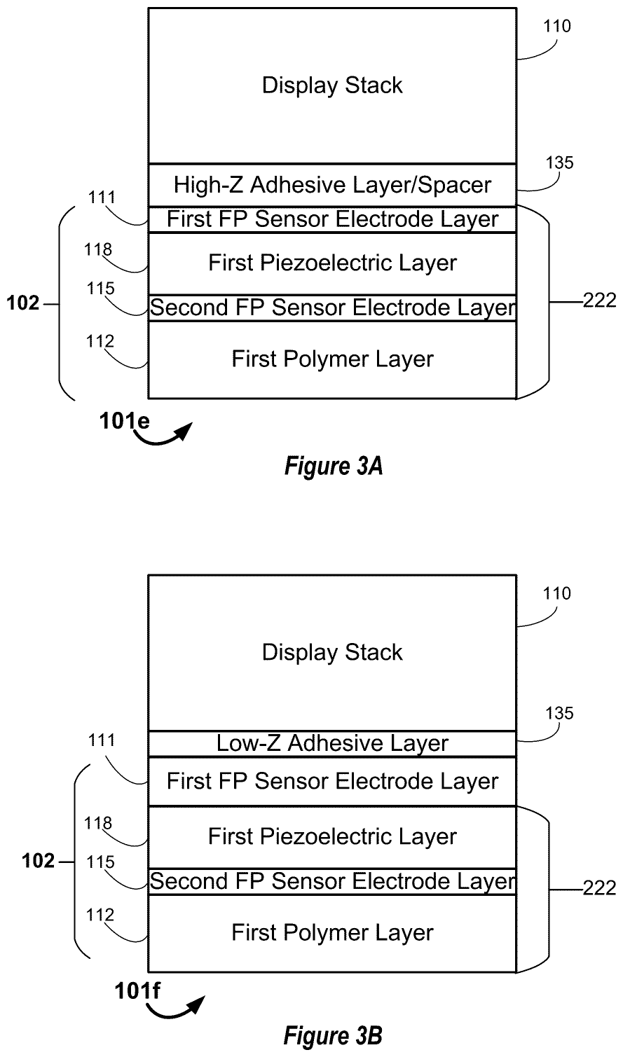

As with other disclosed implementations, the numbers, types and arrangements of elements shown in FIGS. 2A and 2B are merely presented by way of example. For example, the arrangements of elements shown in FIGS. 2A and 2B are sometimes referred to as “receiver down” implementations, because the first polymer layer 112 is relatively closer to the display stack 110 than the first piezoelectric layer 118 is. In some alternative “receiver up” implementations, the first piezoelectric layer 118 is relatively closer to the display stack 110 than the first polymer layer 112 is. Some “receiver up” examples are shown in FIGS. 3A and 3B. Some alternative implementations may include the optional second polymer layer 212 shown with a dashed outline in FIGS. 2A and 2B. In some implementations, the flexible fingerprint sensor stack 102 may include a second piezoelectric layer 120, a third fingerprint sensor electrode layer, or combinations thereof. In some such implementations, the second piezoelectric layer 120 may function as a transmitter and the first piezoelectric layer 118 may function as a receiver, or vice versa.

In the example shown in FIG. 2A, the apparatus 101c includes a high acoustic impedance adhesive layer 135. According to some examples, the high acoustic impedance adhesive layer 135 may be, or may include, a double-sided adhesive metal tape, such as a double-sided adhesive copper tape. In addition to attaching the fingerprint sensor stack 102 to the display stack 110, the high acoustic impedance adhesive layer 135 also functions as one boundary of the acoustic resonator 222. According to this example, as well as the example shown in FIG. 2B, the first fingerprint sensor electrode layer 111 functions as another boundary of the acoustic resonator 222.

According to the example shown in FIG. 2B, the apparatus 101d includes a low acoustic impedance adhesive layer 135 and a high-impedance layer 130. In this example, the high-impedance layer 130 resides between the low acoustic impedance adhesive layer 135 and the first polymer layer 112. According to this example, the high-impedance layer 130 functions as one boundary of the acoustic resonator 222.

Accordingly, in the examples shown in FIGS. 2A and 2B, the first fingerprint sensor electrode layer 111, the first polymer layer 112, the second fingerprint sensor electrode layer 115 and the first piezoelectric layer 118 reside within the acoustic resonators 222. In some such examples, the acoustic resonators 222 may be configured to produce a local maximum of ultrasonic wave transmission at a frequency in the range from 1 MHz to 20 MHz. For example, the present inventors have found that if the high acoustic impedance adhesive layer 135 is a double-sided adhesive copper tape having a thickness in the range of 5 to 30 microns, the first polymer layer 112 is a PI layer having a thickness in the range of 3 to 20 microns, the first piezoelectric layer 118 is a piezoelectric copolymer having a thickness in the range of 5 to 25 microns and the first fingerprint sensor electrode layer 111 is a silver ink having a thickness in the range of 5 to 40 microns, the peak frequency may be tuned in the range from 9 MHz to 13 MHz.

FIGS. 3A and 3B show additional examples of apparatus components according to some disclosed implementations. In these examples, the flexible fingerprint sensor stack 102 and display stack 110 are instances of the fingerprint sensor stack 102 and display stack 110 of FIGS. 1A and 1B. According to these examples, the flexible fingerprint sensor stacks 102 include a first fingerprint sensor electrode layer 111, a first polymer layer 112, a second fingerprint sensor electrode layer 115, and a first piezoelectric layer 118. In these examples, the second fingerprint sensor electrode layer 115 resides on the first polymer layer 112. According to these examples, the first piezoelectric layer 118 acts as an ultrasonic wave transmitter and as an ultrasonic wave receiver.

As with other disclosed implementations, the numbers, types and arrangements of elements shown in FIGS. 3A and 3B are merely presented by way of example. For example, the arrangements of elements shown in FIGS. 3A and 3B are sometimes referred to as “receiver up” implementations, because the first piezoelectric layer 118 is relatively closer to the display stack 110 than the first polymer layer 112 is. In some implementations, the flexible fingerprint sensor stack 102 may include a second piezoelectric layer 120, a third fingerprint sensor electrode layer, or combinations thereof. In some such implementations, the second piezoelectric layer 120 may function as a transmitter and the first piezoelectric layer 118 may function as a receiver, or vice versa.

In the example shown in FIG. 3A, the apparatus 101e includes a high acoustic impedance adhesive layer 135. In some examples, the high acoustic impedance adhesive layer 135 may be, or may include, one or more high acoustic impedance layers in addition to the adhesive(s); these high acoustic impedance layers may be referred to herein as high acoustic impedance spacer layers. According to some examples, the high acoustic impedance adhesive layer 135 may be, or may include, a double-sided adhesive metal tape, such as a double-sided adhesive copper tape. In addition to attaching the fingerprint sensor stack 102 to the display stack 110, the high acoustic impedance adhesive layer 135 also functions as one boundary of the acoustic resonator 222. Accordingly, in the example shown in FIG. 3A, the first fingerprint sensor electrode layer 111, the first polymer layer 112, the second fingerprint sensor electrode layer 115 and the first piezoelectric layer 118 reside within the acoustic resonator 222.

According to the example shown in FIG. 3B, the apparatus 101f includes a low acoustic impedance adhesive layer 135 and a high-impedance first fingerprint sensor electrode layer 111. In this example, the first fingerprint sensor electrode layer 111 resides between the low acoustic impedance adhesive layer(s) 135 and the first piezoelectric layer 118. According to this example, the first fingerprint sensor electrode layer 111 functions as one boundary of the acoustic resonator 222. For example, the first fingerprint sensor electrode layer 111 may be a metallic ink—such as a silver ink—having a thickness in the range of 1 micron to 30 microns, or a layer of copper having a thickness in the range of 1 micron to 30 microns. Accordingly, in the example shown in FIG. 3B, the first polymer layer 112, the second fingerprint sensor electrode layer 115 and the first piezoelectric layer 118 reside within the acoustic resonator 222.

In some examples, the acoustic resonators 222 of FIGS. 3A and 3B may be configured to produce a local maximum of ultrasonic wave transmission at a frequency in the range from 1 MHz to 20 MHz. For example, the present inventors have found that if the high acoustic impedance adhesive layer 135 of FIG. 3A is a double-sided adhesive copper tape having a thickness in the range of 5 to 30 microns, the first polymer layer 112 is a PI layer having a thickness in the range of 3 to 20 microns, the first piezoelectric layer 118 is a piezoelectric copolymer having a thickness in the range of 5 to 25 microns and the first fingerprint sensor electrode layer 111 is a silver ink having a thickness in the range of 5 to 30 microns, the peak frequency may be tuned in the range from 9 MHz to 13 MHz.

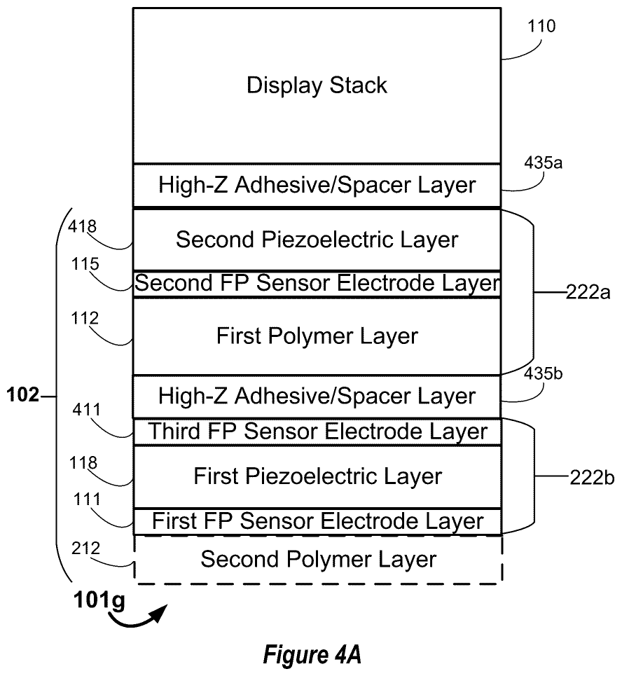

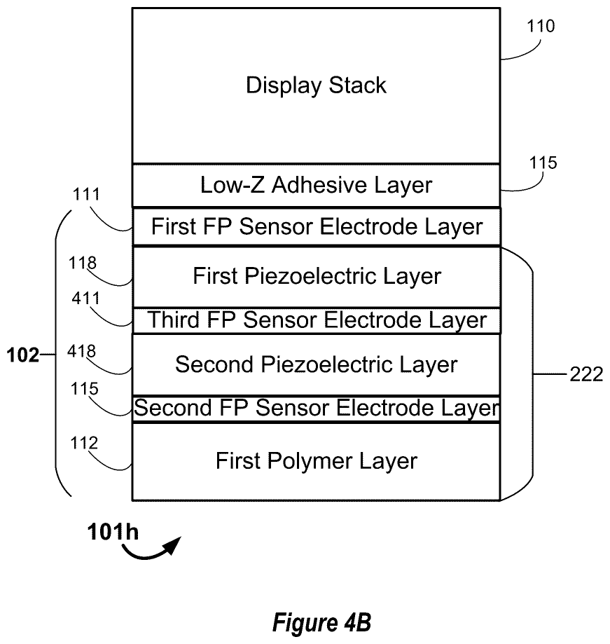

FIGS. 4A and 4B show additional examples of apparatus components according to some disclosed implementations. In these examples, the flexible fingerprint sensor stack 102 and display stack 110 are instances of the fingerprint sensor stack 102 and display stack 110 of FIGS. 1A and 1B. According to these examples, the flexible fingerprint sensor stacks 102 include a first fingerprint sensor electrode layer 111, a first polymer layer 112, a second fingerprint sensor electrode layer 115, a first piezoelectric layer 118, a second piezoelectric layer 418 and a third fingerprint sensor electrode layer 411. In some examples, the first piezoelectric layer 118 and the second piezoelectric layer 418 may be, or may include, a piezoelectric copolymer. According to some examples, the third fingerprint sensor electrode layer 411 may be, or may include, a conductive metal, such as copper, or a metallic ink, such as a silver ink.

As with other disclosed implementations, the numbers, types and arrangements of elements shown in FIGS. 4A and 4B are merely presented by way of example. According to some examples, the second fingerprint sensor electrode layer 115 may function as an ultrasonic receiver and the first fingerprint sensor electrode layer 111 may function as an ultrasonic transmitter. However, in some alternative implementations the second fingerprint sensor electrode layer 115 may function as an ultrasonic transmitter and the first fingerprint sensor electrode layer 111 may function as an ultrasonic receiver. The optional second polymer layer 212 of FIG. 4A may function—at least in part—as a passivation layer for the first fingerprint sensor electrode layer 111. In some examples, the optional second polymer layer 212 may be, or may include a die attach film (DAF) layer.

In the example shown in FIG. 4A, the apparatus 101g includes high acoustic impedance adhesive layers 435a and 435b. According to some examples, the high acoustic impedance adhesive layer layers 435a and 435b may be, or may include, double-sided adhesive metal tape, such as double-sided adhesive copper tape. In addition to attaching the fingerprint sensor stack 102 to the display stack 110, the high acoustic impedance adhesive layer 435a also functions as one boundary of the acoustic resonator 222a. In this example, the acoustic resonator 222a includes the second piezoelectric layer 418, the second fingerprint sensor electrode layer 115 and the first polymer layer 112. According to this example, high acoustic impedance adhesive layer 435b functions as another boundary of the acoustic resonator 222a and also as a boundary of the acoustic resonator 222b. In this example, the acoustic resonator 222b includes the third fingerprint sensor electrode layer 411, the first fingerprint sensor electrode layer 111 and the first piezoelectric layer 118.

According to the example shown in FIG. 4B, the apparatus 101h includes a low acoustic impedance adhesive layer 135 and a high-impedance first fingerprint sensor electrode layer 111. In this example, the first fingerprint sensor electrode layer 111 resides between the low acoustic impedance adhesive layer(s) 135 and the first piezoelectric layer 118. According to this example, the first fingerprint sensor electrode layer 111 functions as one boundary of the acoustic resonator 222. In some examples, the first fingerprint sensor electrode layer 111 may include one or more layers of a conductive metal, such as copper, and one or more polymer layers. According to some examples, the first fingerprint sensor electrode layer 111 may be, or may include, a flexible printed circuit layer.

In some examples, the acoustic resonators 222, 222a and 222b of FIGS. 4A and 4B may be configured to produce a local maximum of ultrasonic wave transmission at a frequency in the range from 1 MHz to 20 MHz. For example, with reference to the acoustic resonators 222a and 222b of FIG. 4A, the present inventors have found that if the high acoustic impedance adhesive layers 435a and 435b are a double-sided adhesive copper tape having a thickness in the range of 5 to 30 microns, the first polymer layer 112 is a PI layer having a thickness in the range of 3 to 20 microns, the first piezoelectric layer 118 is a piezoelectric copolymer having a thickness in the range of 5 to 15 microns, the second piezoelectric layer 418 is a piezoelectric copolymer having a thickness in the range of 5 to 15 microns, and the first and third fingerprint sensor electrode layers 111 and 411 are silver ink having a thickness in the range of 5 to 40 microns, the peak frequency may be tuned in the range from 9 MHz to 13 MHz. With reference to the acoustic resonator 222 of FIG. 4B, the present inventors have found that if the first fingerprint sensor electrode layer 111 is a flexible printed circuit layer that includes PI and copper and has a thickness in the range of 3 to 20 microns, the first piezoelectric layer 118 is a piezoelectric copolymer having a thickness in the range of 5 to 15 microns, the third fingerprint sensor electrode layer 411 is silver ink having a thickness in the range of 3 to 20 microns, the second piezoelectric layer 418 is a piezoelectric copolymer having a thickness in the range of 10 to 30 microns, and the first polymer layer 112 is a PI layer having a thickness in the range of 5 to 20 microns, the peak frequency may be tuned in the range from 9 MHz to 13 MHz.

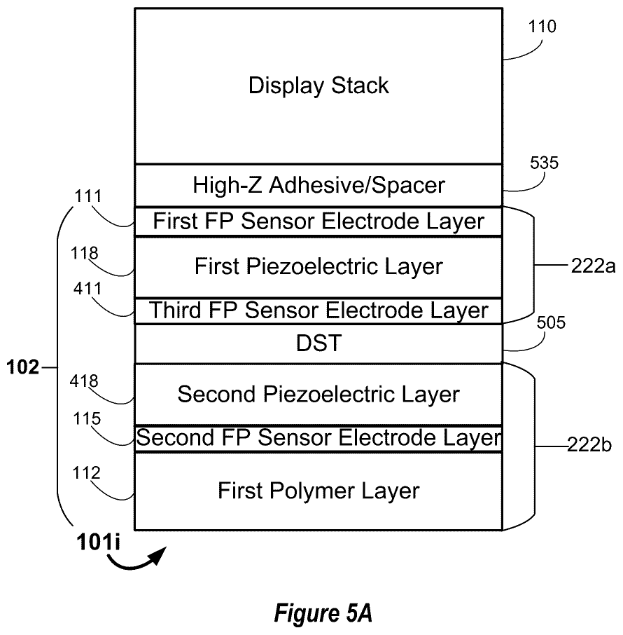

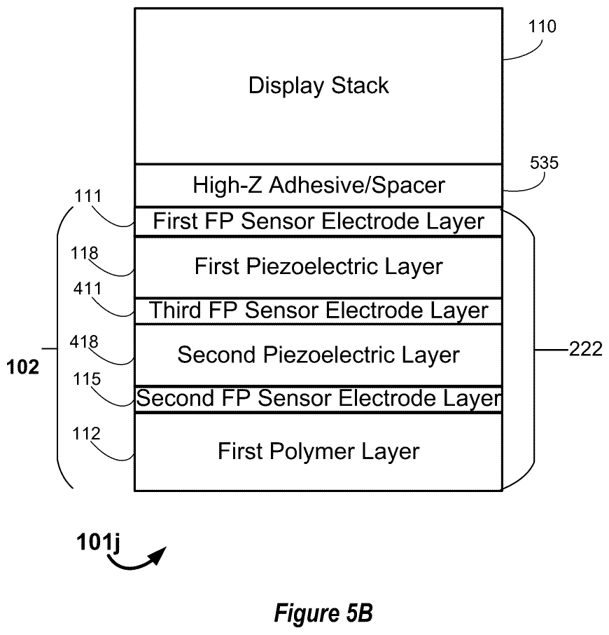

FIGS. 5A and 5B show additional examples of apparatus components according to some disclosed implementations. In these examples, the flexible fingerprint sensor stack 102 and display stack 110 are instances of the fingerprint sensor stack 102 and display stack 110 of FIGS. 1A and 1B. According to these examples, as with the examples shown in FIGS. 4A and 4B, the flexible fingerprint sensor stacks 102 include a first fingerprint sensor electrode layer 111, a first polymer layer 112, a second fingerprint sensor electrode layer 115, a first piezoelectric layer 118, a second piezoelectric layer 418 and a third fingerprint sensor electrode layer 411. In some examples, the first piezoelectric layer 118 and the second piezoelectric layer 418 may be, or may include, a piezoelectric copolymer. According to some examples, the third fingerprint sensor electrode layer 411 may be, or may include, a conductive metal, such as copper, or a metallic ink, such as a silver ink.

As with other disclosed implementations, the numbers, types and arrangements of elements shown in FIGS. 5A and 5B are merely presented by way of example. According to some examples, the second fingerprint sensor electrode layer 115 may function as an ultrasonic receiver and the first fingerprint sensor electrode layer 111 may function as an ultrasonic transmitter. However, in some alternative implementations the second fingerprint sensor electrode layer 115 may function as an ultrasonic transmitter and the first fingerprint sensor electrode layer 111 may function as an ultrasonic receiver.

In the example shown in FIG. 5A, the apparatus 101i include a high acoustic impedance adhesive layer 535 and a double-sided tape (DST) layer 505. According to some examples, the high acoustic impedance adhesive layer 535 and the DST layer 505 may be, or may include, double-sided adhesive metal tape, such as double-sided adhesive copper tape. However, in some examples the DST layer 505 may be another type of double-sided tape, such as a double-sided polyethylene terephthalate (PET) tape. In addition to attaching the fingerprint sensor stack 102 to the display stack 110, the high acoustic impedance adhesive layer 535 also functions as one boundary of the acoustic resonator 222a. In this example, the acoustic resonator 222a includes the third fingerprint sensor electrode layer 411, the first fingerprint sensor electrode layer 111 and the first piezoelectric layer 118. According to this example, the DST layer 505 functions as another boundary of the acoustic resonator 222a and also as a boundary of the acoustic resonator 222b. In this example, the acoustic resonator 222b includes the second piezoelectric layer 418, the second fingerprint sensor electrode layer 115 and the first polymer layer 112.

According to the example shown in FIG. 5B, the apparatus 101j includes a high acoustic impedance adhesive layer 535, but does not include another high acoustic impedance layer within the flexible fingerprint sensor stack 102. In this example, the high acoustic impedance adhesive layer 535 functions as one boundary of the acoustic resonator 222. In some examples, the high acoustic impedance adhesive layer 535 may be, or may include, double-sided adhesive metal tape, such as double-sided adhesive copper tape.

In some examples, the acoustic resonators 222, 222a and 222b of FIGS. 5A and 5B may be configured to produce a local maximum of ultrasonic wave transmission at a frequency in the range from 1 MHz to 20 MHz. For example, the example thickness ranges that are described above for the acoustic resonators 222a and 222b of FIG. 4A also apply to the acoustic resonators 222a and 222b of FIG. 5A. In some examples, the example thickness ranges that are described above for the acoustic resonator 222 of FIG. 4B will also apply to the acoustic resonator 222 of FIG. 5B.

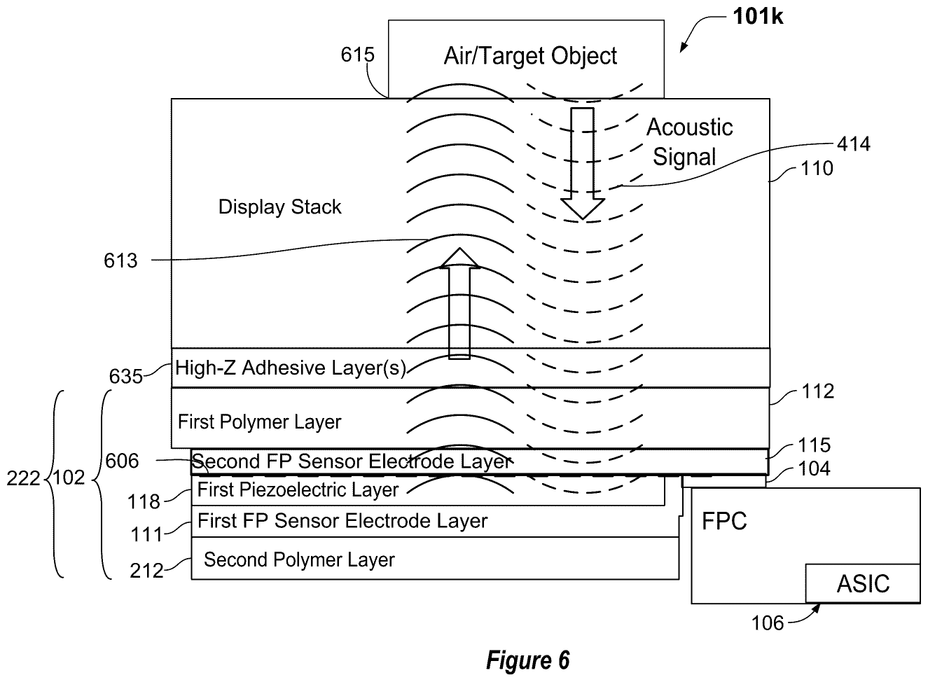

FIG. 6 shows examples of ultrasound traversing components of an apparatus according to some disclosed implementations. According to this example, the apparatus 101k is configured to perform at least some of the methods disclosed herein. According to this implementation, the flexible fingerprint sensor stack 102 includes a first piezoelectric layer 118, a first fingerprint sensor electrode layer 111 on one side of the first piezoelectric layer 118 and an array of fingerprint sensor pixels 606—which are parts of the second fingerprint sensor electrode layer 115—on a second and opposing side of the first piezoelectric layer 118. In this implementation, the first piezoelectric layer 118 includes one or more piezoelectric polymers. In other implementations, the first piezoelectric layer 118 may include other types of piezoelectric materials.

As with other disclosed implementations, the types, number and arrangement of elements, as well as the dimensions of elements, are merely examples. For example, although the arrangement of the elements of apparatus 101k is similar to the arrangement of the elements of apparatus 101c of FIG. 2A, other implementations of apparatus 101k may be arranged differently, for example as shown in another disclosed implementation.

According to this example, the first fingerprint sensor electrode layer 111 resides between a second polymer layer 212 and the first piezoelectric layer 118. In some examples, the second polymer layer 212 may be, or may include, a DAF layer.

In this example, the high acoustic impedance adhesive layer 635 forms one boundary of an acoustic resonator 222 that includes the second fingerprint sensor electrode layer 115, the first fingerprint sensor electrode layer 111, the first piezoelectric layer 118 and the second polymer layer 212. In some examples, the acoustic resonator 222 may be configured to produce a local maximum of ultrasonic wave transmission at a frequency in the range from 1 MHz to 20 MHz. For example, the, the acoustic resonator 222 may have a thickness corresponding to a multiple M of a quarter wavelength corresponding to a frequency in the range from 1 MHz to 20 MHz, where M is an integer or 1 or more.

According to this implementation, the second fingerprint sensor electrode layer 115 and the first fingerprint sensor electrode layer 111 are electrically coupled to at least a portion of the control system 106 via a portion of the interface system 104, which includes electrically conducting material and a flexible printed circuit (FPC) in this instance.

In this example, the apparatus 101k is configured to perform at least some of the methods disclosed herein. In this example, the control system 106 is configured to control the flexible ultrasonic sensor system 102 to transmit one or more ultrasonic waves 613. According to this example, the ultrasonic waves 613 are transmitted through the second fingerprint sensor electrode layer 115 and the display stack 110. According to this example, reflections 614 of the ultrasonic waves 613 are caused by acoustic impedance contrast at (or near) the interface 615 between the outer surface of the apparatus 101k and whatever is in contact with the outer surface, which may be air or the surface of a target object, such as the ridges and valleys of a fingerprint, etc. (As used herein, the term “finger” may refer to any digit, including a thumb. Accordingly, a thumbprint will be considered a type of “fingerprint.”)

According to some examples, reflections 614 of the ultrasonic wave(s) 613 may be detected by the array of sensor pixels 606. Corresponding fingerprint sensor signals may be provided to the control system 106. In some such implementations, fingerprint sensor signals that are used by the control system 106 for fingerprint-based authentication may be based on reflections 614 from a cover/finger interface that are detected by the array of sensor pixels 606. In some implementations, reflections 614 corresponding to a cover/air interface may be detected by the array of sensor pixels 606 and corresponding background fingerprint sensor signals may be provided to the control system 106.

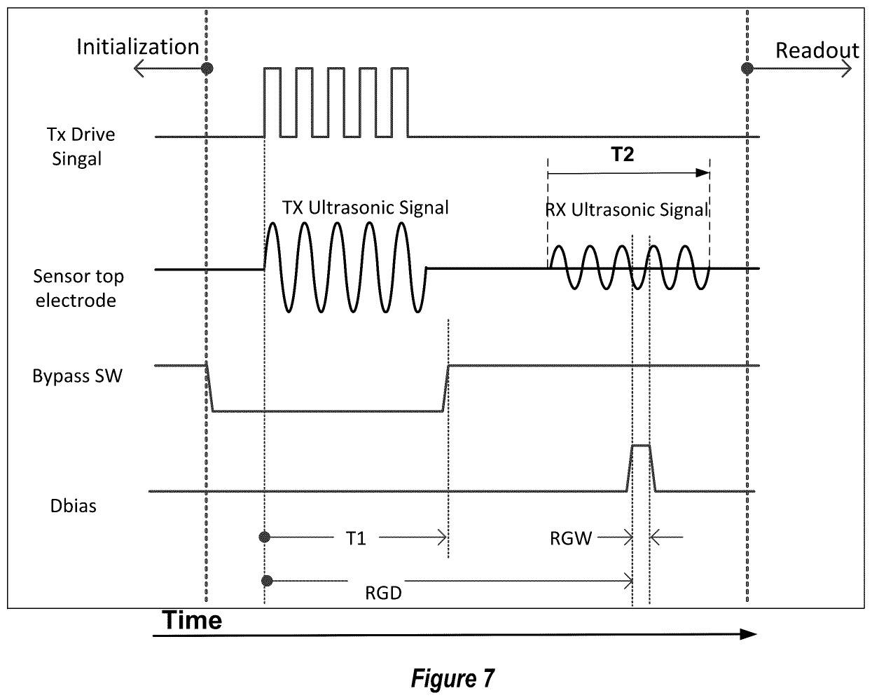

FIG. 7 shows examples of processes that may be involved with transmitting and receiving ultrasonic waves. The processes of FIG. 7 may, for example, be performed by the apparatus 101a of FIG. 1A—for example, at least in part by the control system 106 of FIG. 1A—by the apparatus 101b of FIG. 1B, by the apparatus 101k of FIG. 6, etc., or by a similar device.

In the examples shown in FIG. 7, the transmission (TX) drive signals and corresponding ultrasonic transmission pulses are provided during time interval T1. Ultrasonic waves corresponding to reflections from a target object are received (RX) during a later time interval T2. Ultrasonic waves corresponding to reflections from the target object are sampled by an ultrasonic receiver during a time interval known as a range gate window (RGW), after a time interval known as a range gate delay (RGD). The RGD may, for example, be set according to a two-way travel time to and from a target of interest. In an ultrasonic fingerprint sensor context, one such target of interest may be the ridges and valleys of the epidermis of a finger that has been placed on an outer surface of an apparatus that includes the ultrasonic fingerprint sensor. Other such targets of interest may include sub-epidermal structures of a finger, a wrist, or other body part.

As with other disclosed examples, the types, numbers and arrangements of elements that are shown in FIG. 7 are merely presented by way of example. Other examples may include different types of elements, numbers of elements, arrangements of elements, or combinations thereof. For example, other implementations may involve transmitting more or fewer ultrasonic transmission pulses, may involve a shorter or longer RGD, a shorter or longer RGW, or combinations thereof. Some alternative examples may involve transmitting light instead of ultrasound. The transmitted light may induce one or more tissues, blood, etc., to emit ultrasonic waves that can be detected by an ultrasonic receiver array.

As noted elsewhere herein, data received from fingerprint sensor implementations of the flexible fingerprint sensor stack 102 may sometimes be referred to herein as “fingerprint sensor data,” “fingerprint sensor signals,” “fingerprint image data,” etc., whether or not the received data corresponds to an actual digit or another object from which the flexible fingerprint sensor stack 102 has received data. Such data will generally be received from the fingerprint sensor system in the form of electrical signals. Accordingly, without additional processing such image data would not necessarily be perceivable by a human being as an image.

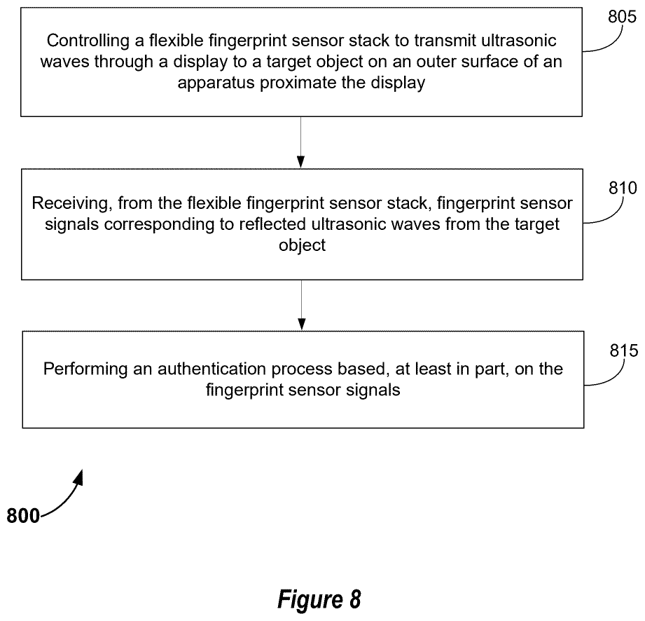

FIG. 8 is a flow diagram that presents examples of operations according to some disclosed methods. The blocks of FIG. 8 may, for example, be performed by the apparatus 101a of FIG. 1A—for example, at least in part by the control system 106 of FIG. 1A—by the apparatus 101b of FIG. 1B, by the apparatus 101c of FIG. 2, by the apparatus 101d of FIG. 3, by the apparatus 101e of FIG. 4, or by a similar device. In some examples, the apparatus may be a mobile device, such as a cellular telephone. However, in other examples, the apparatus may be another type of device, such as a tablet, a laptop, an automobile or component thereof, a wearable device, etc. As with other methods disclosed herein, the methods outlined in FIG. 8 may include more or fewer blocks than indicated. Moreover, the blocks of methods disclosed herein are not necessarily performed in the order indicated. In some implementations, one or more blocks may be performed concurrently.

According to this example, method 800 is a method of controlling a device that includes a flexible fingerprint sensor stack. In this example, block 805 involves controlling a flexible fingerprint sensor stack to transmit ultrasonic waves through a display to a target object on an outer surface of an apparatus proximate the display. According to some examples, the display may be a flexible display, such as a display of a foldable display device (such as a foldable cell phone). In some examples, one or more layers of the flexible fingerprint sensor stack may be at least a part of an acoustic resonator configured to produce a local maximum of ultrasonic wave transmission at a frequency in a range from 1 MHz to 20 MHz. According to this example, block 810 involves receiving, from the flexible fingerprint sensor stack, fingerprint sensor signals corresponding to reflected ultrasonic waves from the target object. In this example, block 815 involves performing an authentication process based, at least in part, on the fingerprint sensor signals. According to some examples, the authentication process involves extracting fingerprint minutiae from the fingerprint sensor signals and comparing the fingerprint minutiae to previously-obtained fingerprint minutiae. The previously-obtained fingerprint minutiae may, for example, have been obtained during a previous enrollment process.

Implementation examples are described in the following numbered clauses:

1. An apparatus, including: a fingerprint sensor stack, including: a first fingerprint sensor electrode layer; a polymer layer; a second fingerprint sensor electrode layer residing on the polymer layer; and a first piezoelectric layer residing between the first fingerprint sensor electrode layer and the polymer layer; and an adhesive layer residing adjacent the fingerprint sensor stack, where the first fingerprint sensor electrode layer, the polymer layer and the first piezoelectric layer are layers of one or more acoustic resonators configured to produce a local maximum of ultrasonic wave transmission at a frequency in a range from 1 MHz to 20 MHz.

2. The apparatus of clause 1, where the fingerprint sensor stack has a modulus of elasticity in a range from 2-5 gigapascals (GPa).

3. The apparatus of clause 1 or clause 2, where a thickness of the fingerprint sensor stack equals a quarter wavelength corresponding to the frequency.

4. The apparatus of clause 3, where the adhesive layer is, or includes, a high-impedance layer having an acoustic impedance in a range from 10-50 MRayls.

5. The apparatus of clause 4, where the polymer layer resides between the first piezoelectric layer and the adhesive layer.

6. The apparatus of clause 4, where the first fingerprint sensor electrode layer resides between the first piezoelectric layer and the adhesive layer.

7. The apparatus of any one of clauses 3-6, where the adhesive layer is, or includes, a low-impedance layer having an acoustic impedance in a range from 1.0-5.0 MRayls, further including a high-impedance spacer layer having an acoustic impedance in a range from 10-50 MRayls, the high-impedance spacer layer residing between the adhesive layer and the polymer layer.

8. The apparatus of any one of clauses 1-7, where: the adhesive layer is, or includes, a low-impedance layer having an acoustic impedance in a range from 1.0-5.0 MRayls; the first fingerprint sensor electrode layer resides between the first piezoelectric layer and the adhesive layer; the first fingerprint sensor electrode layer is, or includes, a high-impedance layer having an acoustic impedance in a range from 10-50 MRayls; and a combined thickness of the polymer layer and the first piezoelectric layer equals a quarter wavelength corresponding to the frequency.

9. The apparatus of any one of clauses 1-7, where a thickness of the fingerprint sensor stack combined with a thickness of the adhesive layer equals a quarter wavelength corresponding to the frequency.

10. The apparatus of clause 9, where the adhesive layer is, or includes, a low-impedance layer having an acoustic impedance in a range from 1.0-5.0 MRayls.

11. The apparatus of any one of clauses 1-10, further including a display stack, where the adhesive layer resides between the fingerprint sensor stack and the display stack, where the adhesive layer and the sensor layer have areas that are less than or equal to a display stack area.

12. The apparatus of clause 11, further including a high-impedance stiffener layer having an acoustic impedance in a range from 10-50 MRayls, the high-impedance stiffener layer residing between the adhesive layer and the display stack.

13. The apparatus of clause 12, where: the adhesive layer resides between the polymer layer and the high-impedance stiffener layer; and the adhesive layer is, or includes, a low-impedance layer having an acoustic impedance in a range from 1.0-5.0 MRayls.

14. The apparatus of clause 13, where: the first fingerprint sensor electrode layer is, or includes, a low-impedance layer having an acoustic impedance in a range from 1.0-5.0 MRayls; and a thickness of the fingerprint sensor stack combined with a thickness of the adhesive layer equals a quarter wavelength corresponding to the frequency.

15. The apparatus of clause 13, where: the first fingerprint sensor electrode layer is, or includes, a high-impedance layer having an acoustic impedance in a range from 10-50 MRayls; and a combined thickness of the polymer layer, the first piezoelectric layer and the adhesive layer equals a half wavelength corresponding to the frequency.

16. The apparatus of any one of clauses 1-15, further including a second piezoelectric layer and a third fingerprint sensor electrode layer, where the third fingerprint sensor electrode layer resides between the first piezoelectric layer and the second piezoelectric layer.

17. The apparatus of clause 16, where the adhesive layer is, or includes, a high-impedance layer having an acoustic impedance in a range from 10-50 MRayls.

18. The apparatus of clause 17, where the polymer layer resides between the first piezoelectric layer and the second piezoelectric layer.

19. The apparatus of clause 18, further including a high-impedance spacer layer residing between the polymer layer and the second fingerprint sensor electrode layer, where a first acoustic resonator is bounded by the high-impedance spacer layer and the adhesive layer and a second acoustic resonator is bounded on one side by the high-impedance spacer layer and includes the first fingerprint sensor electrode layer and the second fingerprint sensor electrode layer.

20. The apparatus of any one of clauses 17-19, where the first piezoelectric layer, the second piezoelectric layer, the first fingerprint sensor electrode layer and the second fingerprint sensor electrode layer reside between the polymer layer and the adhesive layer.

21. The apparatus of clause 20, further including a double-sided tape layer residing between the first piezoelectric layer and the second piezoelectric layer.

22. The apparatus of any one of clauses 16-21, where the adhesive layer is, or includes, a low-impedance layer having an acoustic impedance in a range from 1.0-5.0 MRayls and where the first fingerprint sensor electrode layer is, or includes, a high-impedance layer having an acoustic impedance in a range from 10-50 MRayls.

23. The apparatus of any one of clauses 1-22, further including a second polymer layer residing proximate the first fingerprint sensor electrode layer.

24. The apparatus of clause 23, where the first polymer layer and the second polymer layer are flexible polymers layers having moduli of elasticity in a range from 0.1 gigapascals (GPa) to 11 GPa.

25. The apparatus of clause 23 or clause 24, where the second fingerprint sensor electrode layer is, or includes, a two-dimensional array of pixelated electrodes having associated thin-film transistor (TFT) circuitry.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. An apparatus, comprising:
a fingerprint sensor stack, comprising:
a first fingerprint sensor electrode layer;
a polymer layer;
a second fingerprint sensor electrode layer residing on the polymer layer; and
a first piezoelectric layer residing between the first fingerprint sensor electrode layer and the polymer layer; and
an adhesive layer residing adjacent the fingerprint sensor stack, wherein the first fingerprint sensor electrode layer, the polymer layer and the first piezoelectric layer are layers of one or more acoustic resonators configured to produce a local maximum of ultrasonic wave transmission at a frequency in a range from 1 MHz to 20 MHz.

2. The apparatus of claim 1, wherein the fingerprint sensor stack has a modulus of elasticity in a range from 2-5 gigapascals (GPa).

3. The apparatus of claim 1, wherein a thickness of the fingerprint sensor stack equals a quarter wavelength corresponding to the frequency.

4. The apparatus of claim 3, wherein the adhesive layer comprises a high-impedance layer having an acoustic impedance in a range from 10-50 MRayls.

5. The apparatus of claim 4, wherein the polymer layer resides between the first piezoelectric layer and the adhesive layer.

6. The apparatus of claim 4, wherein the first fingerprint sensor electrode layer resides between the first piezoelectric layer and the adhesive layer.

7. The apparatus of claim 3, wherein the adhesive layer comprises a low-impedance layer having an acoustic impedance in a range from 1.0-5.0 MRayls, further comprising a high-impedance spacer layer having an acoustic impedance in a range from 10-50 MRayls, the high-impedance spacer layer residing between the adhesive layer and the polymer layer.

8. The apparatus of claim 1, wherein:
the adhesive layer comprises a low-impedance layer having an acoustic impedance in a range from 1.0-5.0 MRayls;
the first fingerprint sensor electrode layer resides between the first piezoelectric layer and the adhesive layer;
the first fingerprint sensor electrode layer comprises a high-impedance layer having an acoustic impedance in a range from 10-50 MRayls; and
a combined thickness of the polymer layer and the first piezoelectric layer equals a quarter wavelength corresponding to the frequency.

9. The apparatus of claim 1, wherein a thickness of the fingerprint sensor stack combined with a thickness of the adhesive layer equals a quarter wavelength corresponding to the frequency.

10. The apparatus of claim 9, wherein the adhesive layer comprises a low-impedance layer having an acoustic impedance in a range from 1.0-5.0 MRayls.

11. The apparatus of claim 1, further comprising a display stack, wherein the adhesive layer resides between the fingerprint sensor stack and the display stack, where the adhesive layer and the sensor layer have areas that are less than or equal to a display stack area.

12. The apparatus of claim 11, further comprising a high-impedance stiffener layer having an acoustic impedance in a range from 10-50 MRayls, the high-impedance stiffener layer residing between the adhesive layer and the display stack.

13. The apparatus of claim 12, wherein:
the adhesive layer resides between the polymer layer and the high-impedance stiffener layer; and
the adhesive layer comprises a low-impedance layer having an acoustic impedance in a range from 1.0-5.0 MRayls.

14. The apparatus of claim 13, wherein:
the first fingerprint sensor electrode layer comprises a low-impedance layer having an acoustic impedance in a range from 1.0-5.0 MRayls; and
a thickness of the fingerprint sensor stack combined with a thickness of the adhesive layer equals a quarter wavelength corresponding to the frequency.

15. The apparatus of claim 13, wherein:
the first fingerprint sensor electrode layer comprises a high-impedance layer having an acoustic impedance in a range from 10-50 MRayls; and
a combined thickness of the polymer layer, the first piezoelectric layer and the adhesive layer equals a half wavelength corresponding to the frequency.

16. The apparatus of claim 1, further comprising a second piezoelectric layer and a third fingerprint sensor electrode layer, wherein the third fingerprint sensor electrode layer resides between the first piezoelectric layer and the second piezoelectric layer.

17. The apparatus of claim 16, wherein the adhesive layer comprises a high-impedance layer having an acoustic impedance in a range from 10-50 MRayls.

18. The apparatus of claim 17, wherein the polymer layer resides between the first piezoelectric layer and the second piezoelectric layer.

19. The apparatus of claim 18, further comprising a high-impedance spacer layer residing between the polymer layer and the second fingerprint sensor electrode layer, wherein a first acoustic resonator is bounded by the high-impedance spacer layer and the adhesive layer and a second acoustic resonator is bounded on one side by the high-impedance spacer layer and includes the first fingerprint sensor electrode layer and the second fingerprint sensor electrode layer.

20. The apparatus of claim 17, wherein the first piezoelectric layer, the second piezoelectric layer, the first fingerprint sensor electrode layer and the second fingerprint sensor electrode layer reside between the polymer layer and the adhesive layer.

21. The apparatus of claim 20, further comprising a double-sided tape layer residing between the first piezoelectric layer and the second piezoelectric layer.

22. The apparatus of claim 16, wherein the adhesive layer comprises a low-impedance layer having an acoustic impedance in a range from 1.0-5.0 MRayls and wherein the first fingerprint sensor electrode layer comprises a high-impedance layer having an acoustic impedance in a range from 10-50 MRayls.

23. The apparatus of claim 1, further comprising a second polymer layer residing proximate the first fingerprint sensor electrode layer.

24. The apparatus of claim 23, wherein the first polymer layer and the second polymer layer are flexible polymers layers having moduli of elasticity in a range from 0.1 gigapascals (GPa) to 11 GPa.

25. The apparatus of claim 23, wherein the second fingerprint sensor electrode layer comprises a two-dimensional array of pixelated electrodes having associated thin-film transistor (TFT) circuitry.
